(19) United States
(12) Patent Application Publication
(10) Pub. No.: US 2008/0247859 A1
(43) Pub. Date: Oct. 9, 2008

(54) Streamlined Pallet Handling Apparatus and Method

(76) Inventors: Robert D. Smets, Wilsonville, OR (US); John Stephen Smets, Canby, OR (US)

Correspondence Address: KLARQUIST SPARKMAN, LLP, 121 SW SALMON STREET, SUITE 1600, PORTLAND, OR, 97204, US

(21) Appl. No.: 10/586,323

(22) PCT Filed: Jan. 14, 2005
(86) PCT No.: PCT/US2005/001681

§ 371 Date: Jun. 12, 2008

Related U.S. Application Data
(60) Provisional application No. 60/536,908, filed on Jan. 16, 2004.

(51) Int. Cl. B65G 57/24

(52) U.S. Cl. 414/798.5; 414/801; 198/394

(57) ABSTRACT

Methods and apparatus (10) are disclosed for handling pallets (S) to be inspected and sorted. The method can include tipping a substantially vertically oriented pallet (L) in a forward rotational direction to expose and allow inspection of a trailing major (17) surface of the pallet. A lower portion of the pallet then can be moved to cause the pallet to tip in a rearward rotational direction and land in a substantially horizontal position. The apparatus can include a pallet restraining device (16) for blocking the motion of an upper portion of the pallet as it tips in the forward rotational direction and a conveyor (30) for moving the lower portion of the pallet to cause the pallet to tip in the rearward rotational direction.

### CROSS REFERENCE TO RELATED APPLICATIONS

This application claims the benefit of U.S. Provisional Application No. 60/536,908, filed Jan. 16, 2004, which is incorporated herein by this reference.

### FIELD

This application relates to apparatus and methods for handling pallets.

### BACKGROUND

Pallets have been used for many years in connection with the storing, shipment, and handling of goods. Pallets are normally constructed of wood and are subject to damage because of the rough handling they receive. Therefore, it is necessary to periodically inspect pallets for damage and wear and to sort pallets according to their condition.

One example of a conventional pallet sorting system is shown in FIG. 1. The illustrated pallet sorting system 100 includes a pallet tilting mechanism 102 that feeds a stack 104 of pallets 106 to an off-bearing conveyor 108. In operation, the pallet tilting mechanism 102 receives a generally upright stack 104 of pallets 106, pivots downwardly to tilt the stack 104 to a generally horizontal position, and pushes the stack 104 to displace the pallets 106 along the pallet tilting mechanism 102 and over a support surface 110. The support surface 110 may be horizontal, or may be inclined at a slight upward angle as shown in FIG. 1.

As the pallets 106 are pushed on their side surfaces over the support surface 110, the leading pallet 106′ of the stack 104 is moved into contact with and temporarily restrained by a pallet restraining arm 112 suspended downwardly from a support structure 114. The pallet restraining arm 112 has a counterweight 116 and functions to keep the leading pallet 106′ generally upright until the advancing stack 104 overcomes the resistance of the pallet restraining arm 112 and discharges the leading pallet 106′ from the end of the support surface 110. When discharged, the leading pallet 106′ drops onto a catch plate 118, and its top edge is caused to pivot forwardly so that the leading surface of the leading pallet 106′ (i.e., usually the top major surface of the leading pallet 106′) lies in contact with the off-bearing conveyor 108. As a result, the opposing trailing surface of the leading pallet 106′ (i.e., usually the bottom major surface of the leading pallet 106′) is now oriented upwardly as the leading pallet 106′ moves along the conveyor, which allows for it to be inspected by the operator.

In a subsequent operation, it is often desirable to “turn over” a pallet moving along the conveyor so that its top surface is oriented upwardly. Such an operation might be done manually or with a device called a flipper that rotates one or more pallets 180 degrees to reorient them as desired.

Manually turning over the pallets is usually not desired, and for some applications, the costs and/or space requirements of an additional device such as a flipper or other similar device cannot be justified.

### SUMMARY

To address these and other problems, the support surface or other similar structure can be configured to allow inspection of both sides of the pallet, as well as to allow each pallet to be placed onto the conveyor with its top surface oriented upwardly, thereby eliminating the need for a subsequent operation to reorient the pallet.

In some implementations, the support surface has a second pallet restraining arm to supplement the first pallet restraining arm. The first pallet restraining arm functions to restrain the leading pallet from pivoting until the advancing stack overcomes the first pallet restraining arm's resistance and the leading pallet is discharged. When discharged, the leading pallet drops vertically, such that its upper edge is below the first pallet restraining arm, which allows the pallet to pivot forwardly.

As the leading pallet pivots forwardly, it contacts the second pallet restraining arm which is positioned to stop additional forward pivoting of the pallet beyond a predetermined range. This range may be adjusted to provide an appropriate opportunity to inspect the trailing surface of the pallet (usually its bottom surface). Meanwhile, while the upper edge of the pallet is restrained, the lower edge of the leading pallet is pulled forwardly by the advancing conveyor. With the forward pivoting halted, the forward movement of the lower edge of the pallet effects a rearward pivoting of the pallet, resulting in the bottom surface of the pallet coming into contact with the conveyor.

### BRIEF DESCRIPTION OF DRAWINGS

FIG. 1 is a side view of a prior art pallet sorting system.

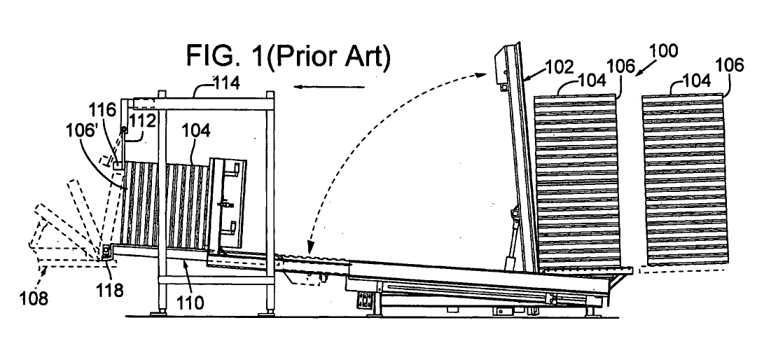

FIG. 2 is a perspective view of a portion of the support surface and the conveyor, showing the leading pallet after it has been pivoted forwardly and is then restrained by the second pallet restraining arm.

FIG. 3 is a perspective view similar to FIG. 2, except showing the lower edge of the leading pallet advancing with the conveyor, having effected a rearward pivoting of the leading pallet.

FIG. 4 is a perspective view similar to FIGS. 2 and 3, except showing the leading pallet just before the bottom surface fully contacts the conveyor.

FIG. 5 is a perspective view similar to FIGS. 2-4, except showing the leading pallet having been advanced through the conveyor for subsequent downstream operations and a next pallet in the stack on the support surface being restrained by the first pallet restraining arm as the handling operation is about to be repeated.

FIG. 6 is a perspective view of the conveyor and also showing a curved conveyor for a downstream operation.

FIG. 7 is a perspective view similar to FIGS. 2-5, except showing the leading pallet as an upside down pallet that has been tipped past the second pallet restraining arm to reorient the pallet.

### DETAILED DESCRIPTION

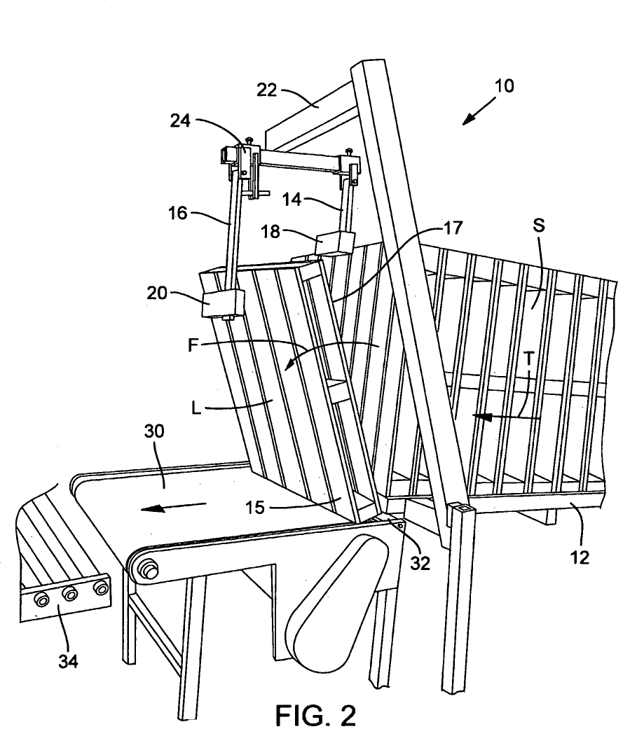

Described below are apparatus and methods providing streamlined handling of pallets. An exemplary apparatus is shown in the perspective views of FIGS. 2-5, which illustrate a handling operation sequence.

Referring to FIG. 2, the portion of an overall handling system 10 shown in the figures includes a support surface 12 along which a stack S of pallets is displaced in the direction of travel T from right to left in the figures, usually by a pushing mechanism (not shown). Also shown is a leading pallet L that has been discharged from the support surface 12, dropped to a conveyor 30 and allowed to pivot forwardly (in the direction F) to the position as shown relative to the other pallets in the stack S.

The support surface 12 may be horizontal or may be inclined in the direction T at a slight angle as shown in the figures. Various devices may be used to displace the pallets along the support surface, such as pushing devices attached to a separate assembly (e.g., a pallet tilting mechanism) or incorporated as part of the support surface.

The position of the leading pallet L as shown in FIG. 2, in which the trailing surface 17 is angled away from the following pallet, provides one opportunity for the operator to inspect this surface. The leading surface 15 of the leading pallet is visible for inspection during several stages of the handling operation.

Suitable positioning of the leading pallet L, e.g., the forward pivoting as shown in FIG. 2, can be achieved in any number of ways. In the illustrated implementation, the upper edge of the leading pallet L is allowed to pivot forwardly until it contacts a second pallet restraining arm 16.

The second pallet restraining arm 16 is spaced forwardly of a first pallet restraining arm 14 in the direction T. In FIG. 2, the first pallet restraining arm 14 is shown restraining a next pallet of the stack S that has not yet been discharged from the support surface 12. In the illustrated implementation, the first and second pallet restraining arms 14 and 16 are suspended from above to contact upper portions of the pallets at different stages during the handling operation. In alternative implementations, one or both of the first and second pallet restraining arms 14 and 16 can be configured to project inwardly from opposite sides of the support surface 12 and to contact the side portions of the pallets instead of the upper portions of the pallets.

In the illustrated implementation, the first pallet restraining arm 14 has a counterweight 18 and is pivotably connected to a supporting member, such as a support frame 22 as shown in FIG. 2. In operation, the first pallet restraining arm 14 serves to restrain the pallet about to be discharged until the advancing stack S overcomes the first pallet restraining arm's resistance and discharges the pallet from the support surface 12.

The first pallet restraining arm 14 and the conveyor 30 are positioned relative to each other such that discharged pallets can pivot forwardly without contacting the first pallet restraining arm 14. In the illustrated implementation, the conveyor 30 is positioned at a lower height than the support surface 12, which allows a discharged pallet to pivot forwardly without interference from the first pallet restraining arm 14.

The second pallet restraining arm 16 can be connected to same supporting member as the first pallet restraining arm 14, i.e., to the support frame 22 as shown, or to a separate member. In the illustrated implementation, the second pallet restraining arm 16 has a counterweight 20. The second pallet restraining arm 16 can have an adjustment device 24 that permits its free end to be angled as desired. In the illustrated implementation, the second pallet restraining arm 16 can pivot, which tends to soften the impact when the leading pallet L initially comes into contact with the second pallet restraining arm 16. The pivoting action of the second pallet restraining arm 16 also allows an operator to easily reorient an occasional upside down pallet by manually pivoting the pallet in the forward direction F past the second pallet restraining arm 16.

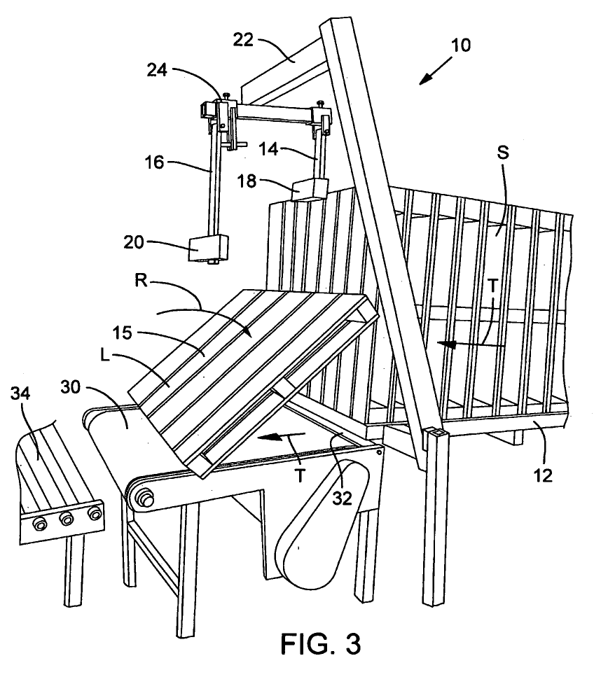

Next in sequence after FIG. 2, FIG. 3 shows the leading pallet L after it has begun to pivot rearwardly in the direction R. The lower edge of the pallet L has been displaced forwardly by the advancing conveyor 30 while the upper edge was restrained by the second pallet restraining arm 16, thereby effecting a pivoting of the pallet L in the rearward direction. Depending upon the relative positioning of the second pallet restraining arm 16 and the forward end of the stack S, the upper edges of the pallet L may slide along the next pallet of the stack S as the pallet pivots rearwardly. The rearward pivoting of the pallet L can be carried out such that less impact results, and thus no separate cushion arm projecting from the conveyor 30 is required, although one could be used if desired.

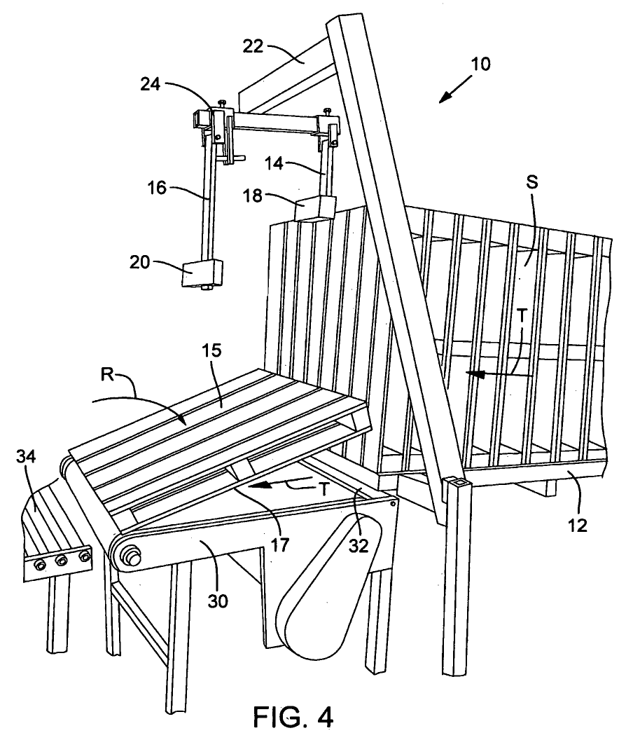

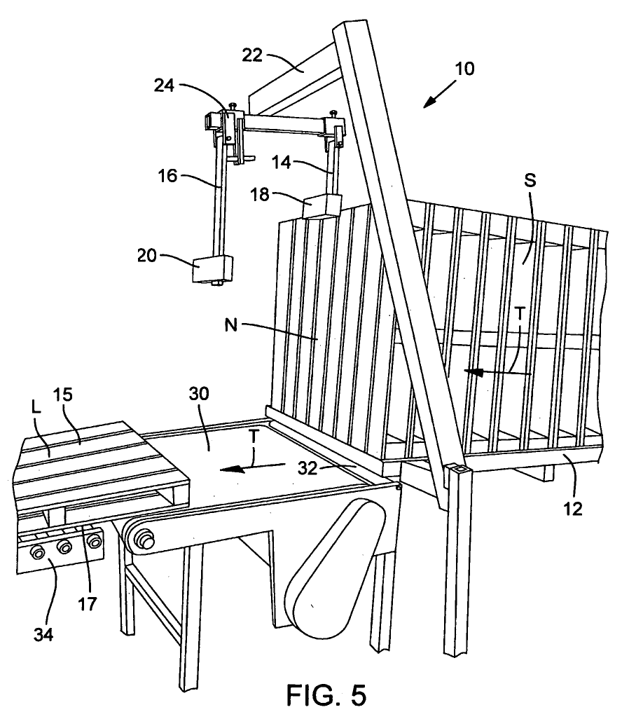

FIG. 4 shows the pallet L just before the trailing surface makes contact with the conveyor. FIG. 5 shows the pallet L with its top surface facing upwardly and moving in the direction T from the conveyor to a subsequent downstream operation and just before the process is about to be repeated for the next pallet N of the stack S.

As shown, the conveyor 30 is positioned downstream of the support surface 12. The conveyor 30 is typically operated intermittently to provide some delay as necessary between various steps of the operation. Such intermittent operation can be programmed to occur on a predetermined cycle, or may be controlled by the operator, i.e., through use of a control to start and stop the conveyor 30.

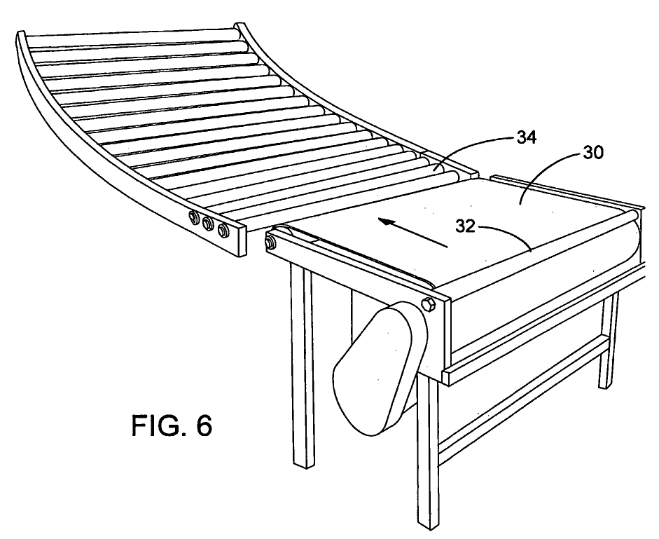

As best shown in FIG. 6, the receiving area where the leading pallet L being discharged is received by the conveyor 30 can be configured to assist in absorbing the shock of the dropping pallet and in causing a lower edge of the pallet to contact the convey 30. According to the illustrated implementation, the conveyor 30 has a member, such as a bar 32 as shown in FIG. 6, that is sufficiently strong to absorb the impact of pallets and is sized and/or shaped such that only one edge of a lower end of the pallet L tends to contact the moving belt of the conveyor, which tends to cause the pallet L to pivot rather than to remain upright as the belt continues to advance.

As also shown in FIG. 6, the conveyor 30 can lead to additional downstream areas, such as, e.g., a curved conveyor 34 as partially shown in the figure. A curved conveyor is desirable because the operator can occupy the smaller area on the inner side of the curved conveyor (which reduces the distance he must travel), whereas the area on the outer side of the curve conveyor can “fan out” with links to multiple other areas, e.g., different sorting designations.

The support surface 12 and arrangement of the first and second pallet restraining arms 14 and 16 has been described consistent with a role of receiving pallets from an upstream operation, such as from a pallet tilting mechanism (sometimes referred to as a “tipper”), and distributing pallets for subsequent downstream operations. The support surface 12 functions to receive and guide pallets along their side surfaces, and thus can be used in other situations, including cases without other upstream and/or downstream operations. The first and second pallet restraining arms 14 and 16, and particularly the second pallet restraining arm 16, can be used in applications other than as illustrated in connection with the support surface 12. For example, the concept of the second pallet restraining arm 16 can be used in any application where it may be desirable to rotate an object, such as a pallet, from its upright orientation to a generally level orientation, in either direction of rotation depending upon the particular circumstances.

If desired, one or more aspects of the operation of the second pallet restraining arm 16 can be automated. Referring to the illustrated implementation, power can be provided, e.g., to permit the second pallet restraining arm 16 to “unlatch” and allow movement of a pallet past the second pallet restraining arm 16 when pivoted forwardly in the direction F. This may be advantageous in situations where minimal manual handling of pallets is desired. A powered second pallet restraining arm 16 may be configured in a longer length and with an attached idler wheel at its free end to facilitate automatic handling.

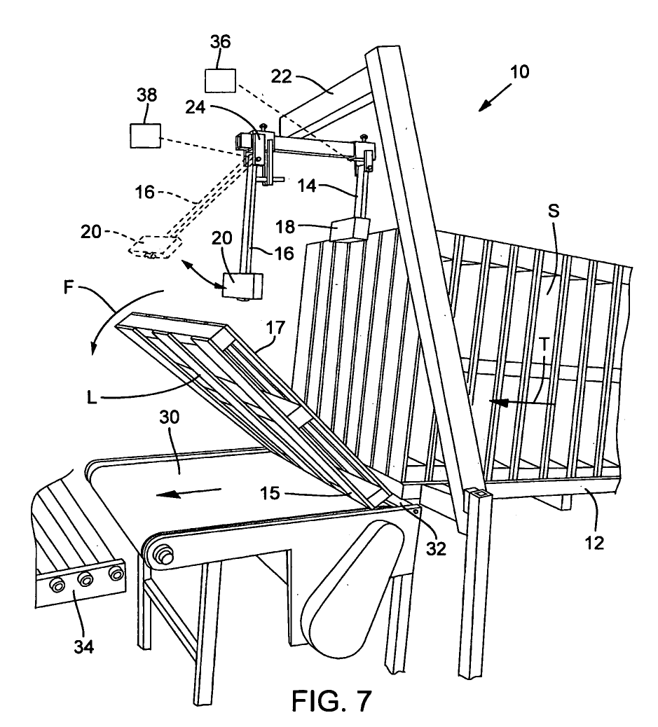

FIG. 7 shows the overall handling system 10 with optional first and second actuators 36 and 38 connected to the first and second pallet restraining arms 14 and 16, respectively. The first and second actuators 36 and 38 can be used to control the movement of the leading pallet L. The first actuator 36 can be triggered to move the first pallet restraining arm 14 and thereby allow the leading pallet L to drop from the support surface 12 and to begin tipping in the forward pivot direction F. The second actuator 38 can be triggered to move the second pallet restraining arm 16, e.g. to reorient upside down pallets by allowing the upside down pallets to continue tipping in the forward pivot direction F. The first and second actuators 36 and 38 can be triggered automatically, such as at a given time interval or in response to a signal from a sensor, or manually by an operator, such as by pushing a button.

In FIG. 7, the leading pallet L is shown as an upside down pallet with its leading surface 15 as its bottom surface and its trailing surface 17 as its top surface. After being dropped from the support surface 12, the leading pallet L is allowed to continue tipping in the forward pivot direction F by manually pushing the leading pallet L past the second pallet restraining arm 16 or by triggering the second actuator 38 to move the second pallet restraining arm 16. In this way, the leading pallet L can be reoriented to match the other pallets traveling along the conveyor 30. After the upper portion of the leading pallet has tipped past the second pallet restraining arm 16, the second pallet restraining arm 16 can be returned to its original position, such as by the force of gravity acting on the counterweight 20 or by reversing the action of the second actuator 36.

The described arm arrangement can be implemented in conjunction with a pallet repair table having a pair of separate conveyor belts spaced from each other (instead of the single belt shown in the figures) and an integrated pallet tipping arrangement.

Although the invention has been disclosed in this patent application by reference to the details of some preferred embodiments, it is to be understood that this disclosure is intended in an illustrative rather than in a limiting sense, as it is contemplated that modifications will readily occur to those skilled in the art within the spirit of the invention.

We claim:

1. A method, comprising:
moving a series of pallets in a process direction, wherein the pallets in the series of pallets each are oriented substantially vertically with leading and trailing major surfaces extending substantially transverse to the process direction;
tipping a pallet in the series of pallets in a forward rotational direction to expose the trailing major surface of the pallet;
blocking the motion of an upper portion of the pallet in the forward rotational direction with a pallet restraining device; and
moving a lower portion of the pallet while the upper portion of the pallet is blocked by the pallet restraining device, such that the pallet tips in a rearward rotational direction and becomes oriented substantially horizontally with its leading major surface facing substantially upward and its trailing major surface facing substantially downward.

2. The method of claim 1, wherein the pallet restraining device comprises an arm and blocking the motion of the upper portion of the pallet comprises at least partially absorbing a force of impact between the arm and the upper portion of the pallet by pivoting the arm.

3. The method of claim 1, wherein moving the lower portion of the pallet comprises engaging a leading edge of a lower end of the pallet with a conveyor, such that the pallet becomes oriented substantially horizontally on the conveyor after tipping in the rearward rotational direction, and further comprising moving the pallet in the process direction with the conveyor.

4. The method of claim 1, wherein the pallet is a first pallet, the pallet restraining device is a second pallet restraining device, further comprising a first pallet restraining device spaced rearwardly of the second pallet restraining device in the process direction, the method further comprising:
resisting movement of the first pallet in the process direction with the first pallet restraining device before tipping the first pallet in the forward rotational direction, wherein the first pallet restraining device comprises an arm with a lower end;
moving the first pallet in the process direction by allowing the arm to pivot;
dropping the first pallet from a first level to a second level lower than the first level, such that the upper portion of the first pallet is positioned below the lower end of the arm; and
pivoting the arm to resist the movement of a second pallet in the series of pallets.

5. The method of claim 4, wherein the first pallet has a lower end with a leading edge and a trailing edge and dropping the first pallet comprises dropping the first pallet onto an obstruction or an inclined surface, such that downward movement of the trailing edge is blocked before downward movement of the leading edge is blocked.

6. The method of claim 5, wherein the leading edge contacts a conveyor as the first pallet tips in the forward rotational direction.

7. The method of claim 1, wherein the pallet is a first pallet and further comprising:
tipping a second pallet in the series of pallets in a forward rotational direction to expose the trailing major surface of the second pallet; and
releasing the pallet restraining device to allow the second pallet to continue tipping in the forward rotational direction, such that the second pallet becomes oriented substantially horizontally with its leading major surface facing substantially downward and its trailing major surface facing substantially upward.

8. The method of claim 7, further comprising blocking the motion of an upper portion of the second pallet in the forward rotational direction with the pallet restraining device before releasing the pallet restraining device.

9. The method of claim 7, wherein the pallet restraining device comprises an arm and releasing the pallet restraining device comprises pivoting the arm.

10. The method of claim 9, wherein pivoting the arm comprises increasing the force exerted by the second pallet on the arm in the forward rotational direction.

11. A pallet handling system, comprising:
a pallet restraining device for blocking the motion of an upper portion of a pallet after the pallet has tipped in a forward rotational direction away from an upright position; and
a conveyor for moving a lower portion of the pallet while the upper portion of the pallet is blocked by the pallet restraining device, wherein moving the lower portion of the pallet with the conveyor while the upper portion of the pallet is blocked by the pallet restraining device causes the pallet to tip in a rearward rotational direction and eventually contact the conveyor in a substantially horizontal position.

12. The pallet handling system of claim 11, wherein the pallet restraining device is configured to unblock the upper portion of the pallet in response to intervention by an operator, such that the pallet continues to tip in the forward rotational direction.

13. The pallet handling system of claim 11, wherein the conveyor is a first conveyor and further comprising a curved, second conveyor positioned downstream from the first conveyor in a process direction.

14. The pallet handling system of claim 11, wherein the pallet restraining device comprises a pivoting arm configured to block the motion of the upper portion of the pallet as the pallet tips in the forward rotational direction.

15. The pallet handling system of claim 14, wherein the pallet restraining device further comprises a counterweight to resist movement of the pivoting arm.

16. The pallet handling system of claim 14, wherein the pallet restraining device further comprises an adjustment device for adjusting the angle of the pivoting arm.

17. The pallet handling system of claim 14, wherein the pallet restraining device further comprises an actuator for moving the pivoting arm.

18. The pallet handling system of claim 14, wherein the pivoting arm is configured to pivot to at least partially absorb a force of impact between the pivoting arm and the upper portion of the pallet.

19. The pallet handling system of claim 14, wherein the pivoting arm is configured to pivot enough to unblock the upper portion of the pallet in response to intervention by an operator, so as to allow the pallet to continue to tip in the forward rotational direction.

20. The pallet handling system of claim 11, wherein the pallet is a first pallet in a series of substantially vertically oriented pallets, the pallet restraining device is a second pallet restraining device spaced forwardly from a first pallet restraining device in a process direction, the first pallet restraining device is operable to control the movement of pallets in the series of substantially vertically oriented pallets, and further comprising a pallet feeding device for moving the series of substantially vertically oriented pallets in the process direction.

21. The pallet handling system of claim 20, further comprising an incline or obstruction at the receiving surface configured to cause the first pallet to tip in the forward rotational direction after landing on the receiving surface.

22. The pallet handling system of claim 20, wherein the first pallet restraining device comprises a pivoting arm configured to allow the first pallet to move in the process direction and to restrain movement of a second pallet in the series of substantially vertically oriented pallets by engaging an upper portion of the second pallet.

23. The pallet handling system of claim 22, wherein the pivoting arm has a lower end, the pallet feeding device further comprises a support surface, the pallet handling system further comprises a receiving surface positioned below the support surface, and the pallet handling system is configured to drop the first pallet from the support surface to the receiving surface, thereby positioning the upper portion of the first pallet below the lower end of the pivoting arm and allowing the first pallet to tip in the forward rotational direction without being obstructed by the pivoting arm.

24. A pallet handling system, comprising:
a pallet feeding device for moving a series of substantially vertically oriented pallets in a process direction, the pallet feeding device comprising a support surface and a first pallet restraining device, the first pallet restraining device having a first pivoting arm with a lower end;
a receiving surface positioned below the support surface, the receiving surface configured to receive a first pallet in the series of substantially vertically oriented pallets dropped from the support surface, thereby positioning an upper portion of the first pallet below the lower end of the first pivoting arm;
an incline or obstruction on the receiving surface configured to cause the first pallet to tip in a forward rotational direction after landing on the receiving surface;
a second pallet restraining device spaced forwardly of the first pallet restraining device in the process direction and comprising a second pivoting arm, the second pallet restraining device blocking the motion of the upper portion of the first pallet as it tips in the forward rotational direction; and
a conveyor for moving a lower portion of the first pallet while the upper portion of the first pallet is blocked by the second pallet restraining device, wherein moving the lower portion of the first pallet with the conveyor while the upper portion of the first pallet is blocked by the second pallet restraining device causes the first pallet to tip in a rearward rotational direction and land on the conveyor in a substantially horizontal position.
